(19) United States
(12) Patent Application Publication
(10) Pub. No.: US 2009/0249831 A1
(43) Pub. Date: Oct. 8, 2009

(54) STRING INSTRUMENT/PICK ARTICLE OF JEWELRY

(76) Inventor: B. Scott Morris, New Castle, DE (US)

Correspondence Address: Connolly Bove Lodge & Hutz, LLP, P.O. Box 2207, Wilmington, DE, 19899-2207, US

(21) Appl. No.: 12/420,172

(22) Filed: Apr. 8, 2009

Related U.S. Application Data
(60) Provisional application No. 61/043,221, filed on Apr. 8, 2008.

(51) Int. Cl. A44C 13/00; G10D 3/16

(52) U.S. Cl. 63/1.12; 84/322

(57) ABSTRACT

A combination string instrument/pick article of jewelry comprises a simulated miniature sized string instrument, such as a guitar, which includes a neck and a body and which is in the miniaturized shape of a corresponding full sized instrument. The body has an attachment area on its front face. A full size pick is mounted in the attachment area. The pick contains designator information on its front face, such as information to identify the string instrument for which the pick is intended to be used.

### CROSS REFERENCE TO RELATED APPLICATION

This application is based on provisional application Ser. No. 61/043,221, filed Apr. 8, 2008, all of the details of which are incorporated herein by reference thereto.

### BACKGROUND OF INVENTION

Various types of string instruments are played through use of a pick. Such picks differ in material and dimension in accordance with the particular instrument that is to be played.

There is, presently on the market, a necklace marketed by Guistar Picks which is in the form of a simulated miniature guitar wherein a hole or cutout is formed through the simulated body portion of the guitar in a shape similar to that of a full size pick. A peripheral rim or shoulder extends inwardly from the edge of the hole at the backside of the simulated guitar. A bridge member spans the rear of the simulated guitar extending from the end of the body inwardly to about the central area of the hole or cutout. This creates a pocket formed by the shoulder or peripheral rim on one side and the bridge member on the other side. A full size pick is then inserted into the pocket. The simulated miniature guitar has a loop for receiving a chain to thereby comprise a necklace. The pick itself contains on its outer surface a simulated fingerprint. U.S. Pat. No. 5,859,377 and U.S. Published application US2007/008775 illustrate and describe such a pick. This necklace thus has the double function of being a necklace which includes a simulated fingerprint impression on the pick and also of being able to have the pick itself detached for use in playing a guitar.

### SUMMARY OF INVENTION

An object of this invention is to provide an article of jewelry based upon, but differing from the type of article of necklace discussed above.

A further object of this invention is to provide such an article of jewelry which contains a pick that can be detached and then used with a string instrument for which is it particularly adapted.

In accordance with this invention the article of jewelry includes a simulated miniature sized string instrument. An enlarged open area extends through the body of the miniature sized instrument. A full size pick is detachably mounted in the open area for ready removal so that the pick can be used in the playing of a corresponding fill size instrument. The pick includes identifier indicia or designator information on its front face to identify the instrument for which it is intended to be used.

The string instrument could be a guitar and a chain could be mounted to the miniature size string instrument to form a necklace. A plurality of picks could be mounted in the open area including picks having different identifier indicia for use with other string instruments.

### THE DRAWINGS

FIG. 1 is a front elevational view of an article of jewelry in accordance with this invention;

FIG. 1A is a view similar to FIG. 1 showing a simulated miniature size string instrument with the pick removed;

FIGS. 2-3 are top and bottom views of the article of jewelry shown in FIG. 1;

FIG. 4 is a rear view, partly broken away, of the article of jewelry shown in FIGS. 1-3;

FIG. 4A is a view similar to FIG. 4 showing a simulated miniature sized string instrument with the pick removed;

FIGS. 5 and 6 are end elevational views of the article of jewelry shown in FIGS. 1-4;

FIG. 7 is a plan view showing the article of jewelry of FIGS. 1-6 as part of a necklace;

FIG. 8 is a front elevational view of the pick incorporated in the article of jewelry shown in FIGS. 1-7;

FIG. 9 is a side elevational view of the pick shown in FIG. 8;

FIG. 10 is a rear elevational view of the pick shown in FIGS. 8-9;

FIG. 11 is a side elevational view of the pick shown in FIGS. 8-10;

FIG. 12 is a front elevational view of a further article of jewelry in accordance with this invention;

FIG. 13 is a cross sectional view taken through FIG. 12 along the line 13-13;

FIG. 14 is a left end elevational view, partially broken away, showing a plurality of picks in a modified form of this invention; and

FIGS. 15-19 are front elevational views of modified picks in accordance with this invention.

### DETAILED DESCRIPTION

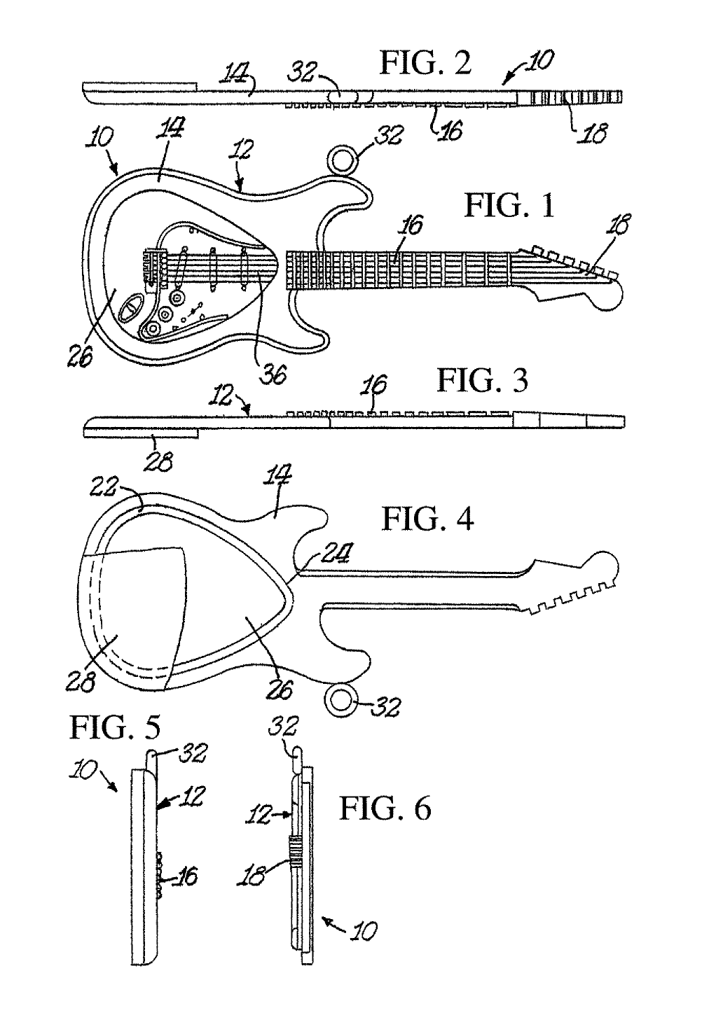

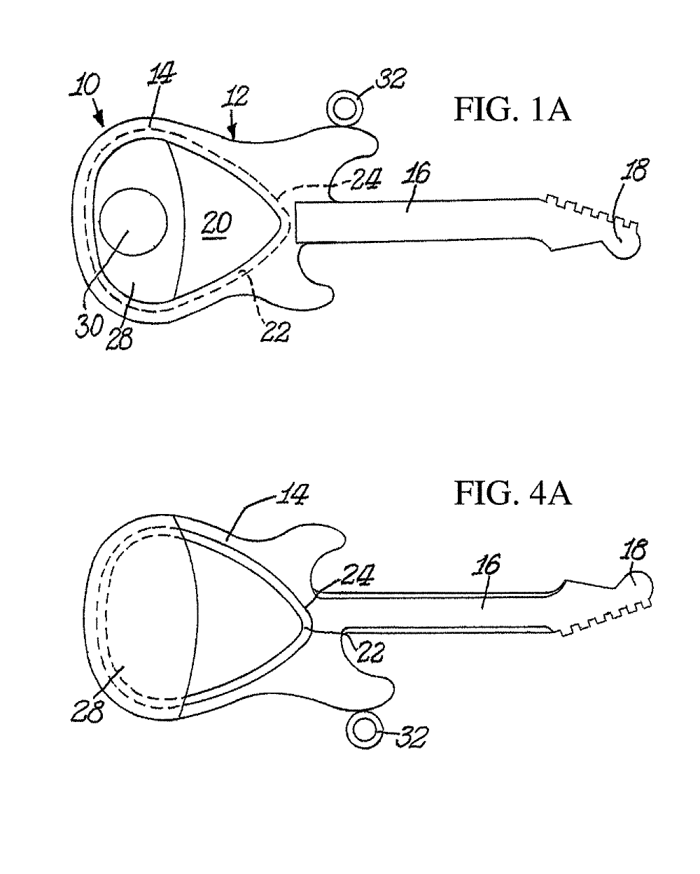

FIGS. 1-6 illustrate a combination string instrument pick article of jewelry 10 in accordance with this invention. As shown therein the article of jewelry comprises a simulated miniature size string instrument 12. In the illustrated form the string instrument 12 is a particular model guitar and includes a body 14, a neck 16 and a head stock 18. Preferably, the outer face (which is shown in FIG. 1) of the simulated guitar 12 includes a replica of the actual details of a guitar such as the strings. The degree of detail shown on the front face of guitar 12 could vary. Preferably, however, the overall shape of guitar 12 would be the same as an actual specific model guitar but of miniaturized size.

As shown in FIGS. 1A and 4A the body 14 includes an attachment area in the form of a hole or cutout 20 extending completely through the body. The hole or cutout 20 has a shoulder 22 located on the front surface of the body 14 to create a ledge peripherally inwardly of generally triangular or tear-shaped rim 24 which is of a size and shape corresponding to the size and shape of pick 26. As a result, the pick 26 could snap into the cutout 20 with the edge of the pick fitting against the rim 24 and with the pick being retained in the cutout 20 by resting on shoulder 22. A bridging member 28 is located against the rear surface of simulated body 14. Bridging member 28 is of sufficient size, shape and location to maintain the pick 26 mounted in cutout 20 and thereby prevent the pick from readily falling out of the cutout 20. As illustrated, bridging member 28 is co-terminus with the edge of body 14 remote from neck 16 and extends over a length that would cover about ½ of the cutout 20 thereby leaving a completely open area over the other half. As a result, pick 26 could be mounted to body 14 by inserting the widened portion of pick 26 into cutout 22 and then over bridging member 28. Pick 26 would then be slid into place until it is completely inserted. If desired cushioning material 30 could be provided on bridging member 28 to protect the pick 26 and to facilitate the insertion and removal of pick 26 by providing yieldability between the rigid bridging member 28 and the pick 26.

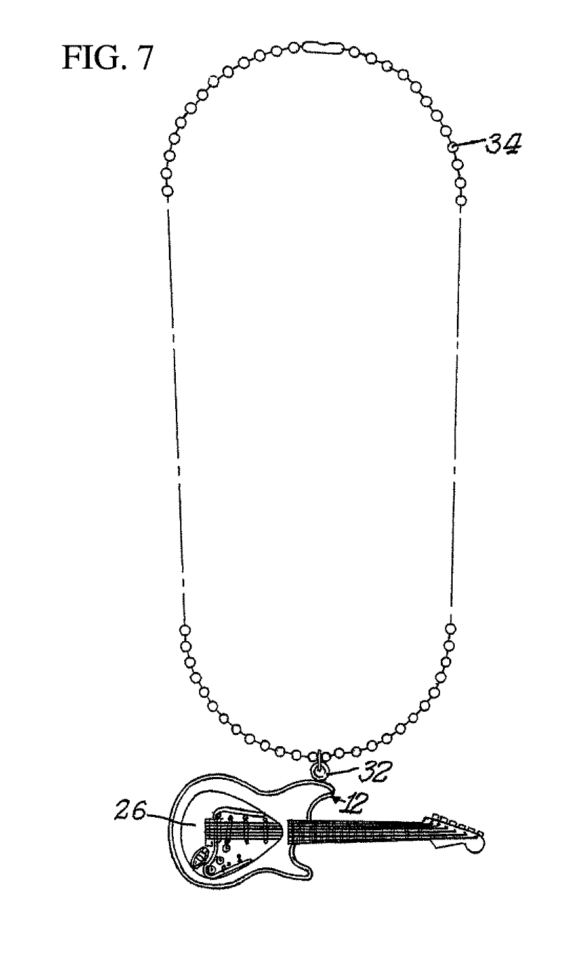

As illustrated, a loop 32 is provided at any suitable location on the simulated guitar 12 such as on the body 14 for receiving a chain 34 as illustrated in FIG. 7 to form a necklace as the article of jewelry.

To this point the description of the necklace is similar to the Guistar Pick necklace.

All picks are not the same. Instead, picks are manufactured from various materials, such as DELRIN, celluloid nitrate and PVC plastic. In addition, picks come in various gauges such as from 0.50 mm up to 2.0 mm. Popular sizes are 0.50 mm, 0.71 mm and 0.96 mm. Different players prefer different gauges and prefer that certain specific picks be used with specific model instruments.

In accordance with this invention, unlike the Guistar Pick necklace, the front face of pick 26 includes identifier indicia or designator information 36 to identify the particular string instrument such as a specific model from a specific manufacturer for which the pick would be intended to be used. In the embodiment of FIG. 1 the identifier indicia 36 is a completion of the details such as the strings and other details (i.e., pick guards, volume/tone knobs, etc.) that would be on a full sized guitar to complete the look of the body of the guitar. Accordingly, a guitar player seeing the front face of pick 26 would know what guitar is intended to be played with pick 26. The inclusion of such identifier indicia or designator information marks a distinct difference from the aforenoted Guistar Pick necklace in that such prior pick does not include any such identifier indicia representative of a particular string instrument or guitar as in FIGS. 1-7, but rather includes simulated fingerprints.

The embodiment of FIGS. 1-7 is also illustrated in design patent application Ser. No. 29/303,359 filed Feb. 7, 2008, now U.S. Pat. No. D584,984 all of the details of which are incorporated herein by reference thereto.

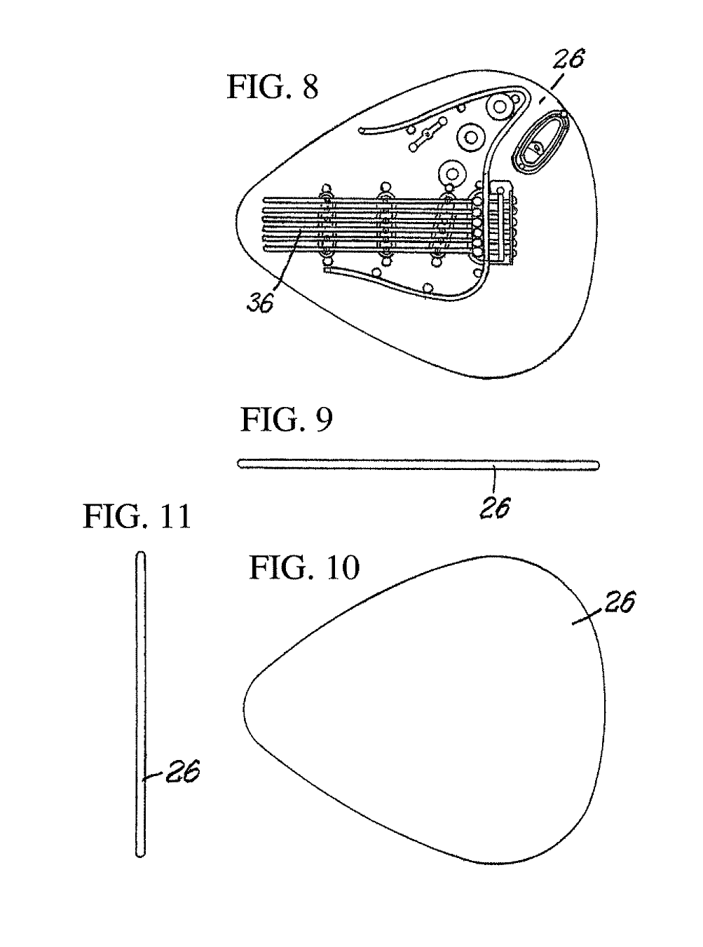

FIG. 8 shows in greater detail the identifier indicia or designator information 36 that would represent the specific guitar for which pick 26 is intended. Because only the front face of pick 26 would be readily visible when pick 26 is mounted to simulated miniature sized guitar 12, it is not necessary to have identifier indicia on the rear face. Thus, FIG. 10 shows a completely blank rear face, except to the extent that some of the detail from the front face of pick 26 may show through to the back face depending upon the material used and its degree of transparency or translucency for pick 26. As shown in FIGS. 8-11 pick 26 is essentially a thin flat plate of tear drop or generally triangular shape and except for the inclusion of the identifier indicia 36 would be the same as conventional picks made for the particular guitar representative of identifier indicia 36 or designator information with regard, for example, to material and gauge size.

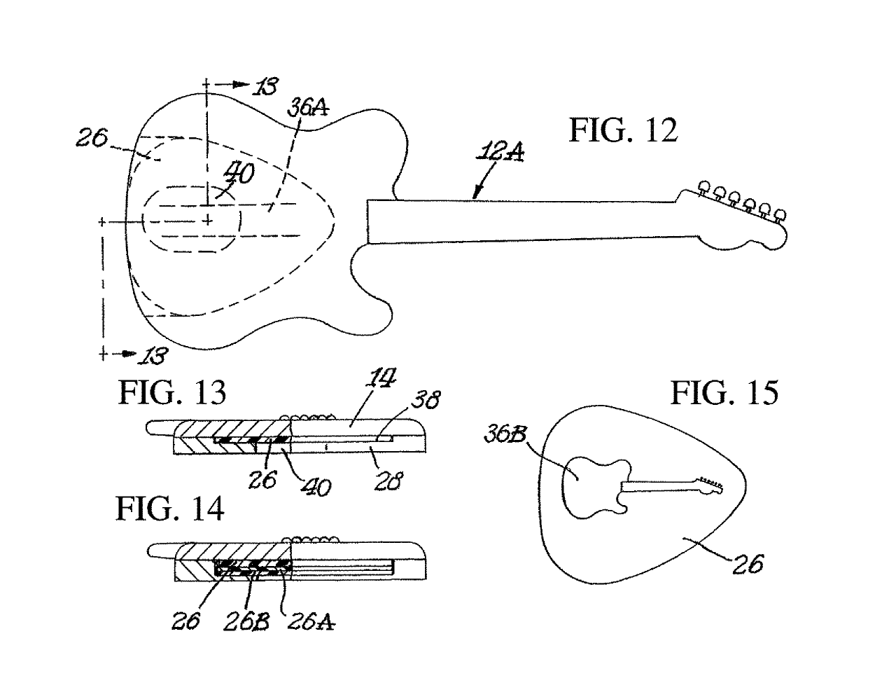

As previously described the identifier indicia or designator information 36 in the embodiment of FIGS. 1-11 is in a form wherein the front face of the pick 26 contains a visual representation of the portion of the guitar 12 which would be located in the body 14 where the pick is physically located. Other forms of identifier indicia or designator information could also be used. For example, FIG. 12 illustrates a different model guitar and as the identifier indicia or designator information 36A there is simply printed material which could be words or other verbage identifying the name of the instrument such as by manufacturer and brand and/or by some form of logo representative of the instrument for which the pick 26 corresponds.

FIG. 15 illustrates yet another pick 26 having as its identifier indicia or designator information 36B a picture or some other visual representation of a specific guitar with which the pick is intended to be used.

FIGS. 12-13 illustrate an alternative manner of mounting the pick 26 into the attachment area or cutout in the body of a simulated miniature sized string instrument which, in FIG. 12, is also illustrated as a guitar 12A. In the embodiment of FIGS. 12-13 a slot 38 is formed between the body 14 and the bridging member 28 to permit the pick to be inserted into and removed from the cutout. In order to facilitate manipulation of the pick an access hole 40 could be provided in bridging member 28 to permit the user's finger to press against the pick and push the pick either into or out of the cutout. Alternatively, the exposed portion of the cutout would provide access to the pick which would permit the user to slide the pick into or out of the cutout.

A further feature of this invention is the provision of a plurality of picks in the cutout. FIG. 14, for example, illustrates three picks 26, 26A and 26B mounted in superimposed fashion with respect to each other in the cutout. Each of the picks would have its own identifier indicia so that the user would know with what string instrument the pick is intended to be used. For example, all three picks could be intended to be used with the same string instrument or one or more picks could be intended to be used with different string instruments. The identifier indicia would make clear to the user the intended purpose of the pick.

It is to be understood that while the various figures illustrate a guitar as the string instrument other simulated miniaturized string instruments which would be played with a pick could be used such as a mandolin, banjo, harpsichord, etc.

As is apparent the present invention thus provides a unique article of jewelry which includes a combination simulated miniature sized string instrument and a full size pick as part of the article of jewelry such as a necklace, pendant, pin, key fob, charm, key chain, a dangle (such as a jacket zipper pull) or bracelet. The pick in some of the practices of the invention is constructed in such a manner that a user would know what string instrument, such as what model guitar for which the pick is intended to be used.

It is to be understood that the invention can be broadly practiced with variations of the specific embodiments previously described. For example, instead of mounting the pick to the simulated string instrument by use of a cut-out, other manners of detachable attachment could be used. For example, the simulated string instrument could have clips or slots for detachably holding the pick.

The invention could also be practiced using various types of designator information. FIGS. 1-7 show the designator information to be the completion of the simulated musical instrument in the area where the pick is mounted. In that sense, the designator information is a simulated portion of a musical instrument. Other types of simulated portions of a musical instrument could also be used.

As previously indicated with regard to FIG. 12, the designator information could be in the form of a verbal representation of the string instrument for which the pick is intended to be used.

FIG. 15 illustrates the designator information to be in the form of a simulated instrument itself, namely, a guitar. Other forms of designator information could include the simulation of different types of musical instruments not limited to the specific type of guitar for which the pick is intended to be used, although that is the preferred form. Such other forms of musical instruments need not be string instruments. An example is a base drum.

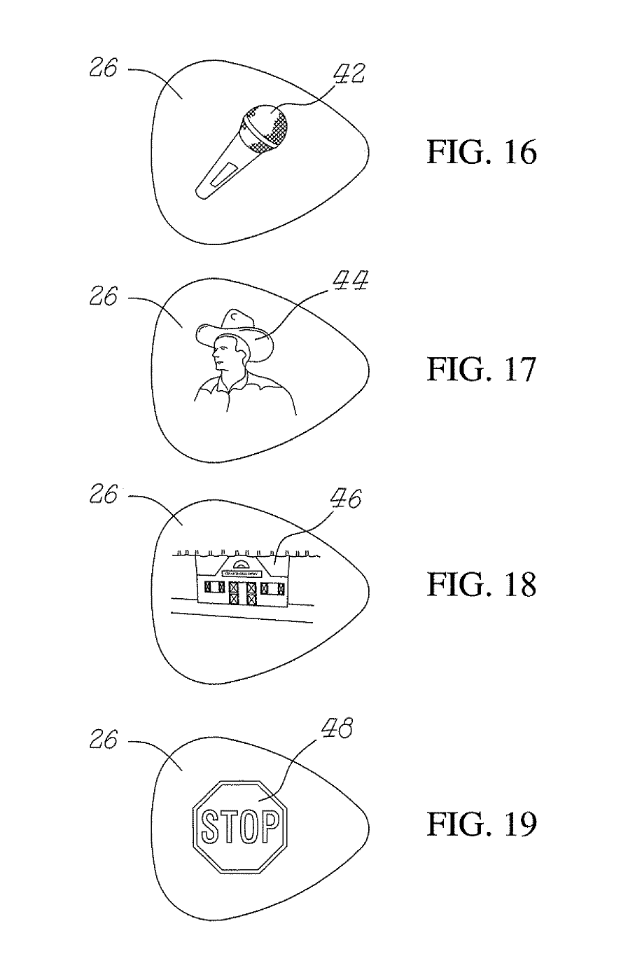

FIG. 16 illustrates a pick 26 having designator information in the form of simulated sound equipment 42. The illustrated form of sound equipment is a microphone. Other forms of sound equipment could also be used, such as an effects pedal, speakers, sound boards or amplifiers.

FIG. 17 illustrates a practice of the invention where the designator information is a depiction of a musical artist 44, Preferably the artist would be one who would be associated with the particular form of simulated instrument to which the pick 26 is attached. The invention, however, could be practiced where the artist or a group of artists, such as a band, is depicted who not necessarily use the simulated string instrument.

FIG. 18 illustrates a practice of the invention wherein the designator information is a depiction of a structural venue 46. An example could be the Ryman Theatre of the Grand Old Opry or could be the Orpheum Theatre in Memphis, Tenn. Instead of depicting the actual structural venue, a logo associated with the structural venue could be used as the designator information.

The invention could also be broadly practiced where the designator information is not specifically directed to a musical theme. FIG. 19, for example, illustrates a pick 26 having as its designator information a street sign 48, such as a stop sign. Other street “signs” could be a traffic light or other form of street sign indicating, for example, a curve in a road or an intersection.

The invention could also be practiced where each side (i.e., front and back) of the pick has designator information. The designator information could be identical on both sides or could be different. Where the designator information is different, each side might include designator information from the same group such as a different musical instrument on each side. Alternatively, the designator information on both sides could be distinctly different from each other, such as a musical artist on one side and a base drum on the other side.

As is apparent, the present invention could be broadly practiced with various types of articles of jewelry and with various types of designator information. The pick could be mounted to the simulated instrument in various manners by being mounted at an attachment area of the simulated instrument. Such attachment area is preferably located at the front face of the instrument and could be an open area or cutout into which the pick would fit or could incorporate any other suitable mounting structure for detachably holding the pick to the simulated instrument.

What is claimed is:

1. A string instrument/pick article of jewelry comprising a simulated miniature size string instrument which includes a neck and a body having the shape of a full size instrument, said simulated instrument having a front face, an attachment area in said front face, a full size pick detachably mounted at said attachment area, said pick having a front face, designator information on said front face of said pick, and said designator information being selected from the group consisting of a simulated portion of a musical instrument, the simulation of a musical instrument, simulated sound equipment, a depiction of a musical artist, a depiction of a structural venue, a logo for a structural venue, a verbal representation of the string instrument for which said pick is intended to be used, and a simulated street sign.

2. The jewelry of claim 1 wherein said simulated miniature sized string instrument is a guitar.

3. The jewelry of claim 1 wherein said article of jewelry is a necklace.

4. The jewelry of claim 1 wherein there are a plurality of said picks mounted at said attachment area, and each of said picks containing designator information on its front face.

5. The jewelry of claim 1 wherein said front face of said simulated instrument has simulated strings in said neck and extending to at least said body, said attachment area being an open area in said front face of said simulated instrument, and said designator information including simulated strings located on said front face of said pick to create a continuation of said simulated strings on said simulated instrument.

6. The jewelry of claim 5 wherein said simulated instrument is a specific model corresponding to the shape and proportions of the full sized model, and said designator information including simulated structure on said pick in addition to said simulated strings on said pick which correspond to said model.

7. The jewelry of claim 1 wherein said designator information is a pictorial representation of a string instrument for which said pick is intended to be used.

8. The jewelry of claim 1 wherein said designator information is a verbal representation of the string instrument for which said pick is intended to be used.

9. The jewelry of claim 1 wherein said pick is part of a cartridge having a plurality of said picks.

10. The jewelry of claim 1 wherein there are a plurality of said picks mounted at said attachment area, and at least one of said picks includes designator information which differs from said designator information on at least one other of said picks.

11. The jewelry of claim 1 wherein said article of jewelry being selected from the group consisting of a necklace, a pendant, a pin, a key fob, a charm, a key chain, a bracelet, and a dangle.

12. The jewelry of claim 1 wherein said designator information is included on said front face of said pick and also on the back face of said pick.

13. The jewelry of claim 1 wherein said designator information comprises a simulated portion of a musical instrument.

14. The jewelry of claim 1 wherein said designator information comprises the simulation of a musical instrument.

15. The jewelry of claim 1 wherein said designator information comprises simulated sound equipment.

16. The jewelry of claim 1 wherein said designator information comprises the depiction of a musical artist.

17. The jewelry of claim 1 wherein said designator information comprises the depiction of a structural venue.

18. The musical instrument of claim 1 wherein said designator information comprises a logo for a structural venue.

19. The jewelry of claim 1 wherein said designator information comprises a simulated street sign.

20. The jewelry of claim 1 wherein said simulated string instrument is selected from the group consisting of a guitar, a mandolin, a banjo and a harpsicord.
